(19) United States
(12) Patent Application Publication
(10) Pub. No.: US 2024/0293938 A1
(43) Pub. Date: Sep. 5, 2024

(54) ROBOTIC ARM ASSEMBLY FOR ELECTRIC VEHICLE CHARGER

(71) Applicant: Ford Global Technologies, LLC, Dearborn, MI (US)

(72) Inventors: Jon Zimmerman, Ferndale, MI (US); Hussein Chami, Dearborn, MI (US); Brian McIntyre, Dexter, MI (US); Francis Maslar, Grosse Ile, MI (US); Raj Sohmshetty, Canton, MI (US); Yifan Chen, Ann Arbor, MI (US); Smruti Panigrahi, Novi, MI (US)

(73) Assignee: Ford Global Technologies, LLC, Dearborn, MI (US)

(21) Appl. No.: 18/177,954

(22) Filed: Mar. 3, 2023

(51) Int. Cl. B25J 9/16; B25J 15/00; B25J 15/02; B60L 53/16; B60L 53/35; G06V 20/50

(52) U.S. Cl. CPC B25J 9/1697; B25J 9/1687; B25J 15/0066; B25J 15/0253; B60L 53/16; B60L 53/35; G06V 20/50

(57) ABSTRACT

A tool for a robotic arm is configured to move an electric charger to an electric vehicle. The tool includes a base configured to be secured to the robotic arm, a vision sensor disposed on the base, a hook including a proximal end fixed to the base, a distal end having an arcuate shape, and a void defined between the proximal end and the distal end, and a gripper extending below the base. The gripper includes a track, two opposing fingers configured to move along the track, and an actuator configured to retract the two opposing fingers along the track.

### FIELD

The present disclosure relates to systems and methods for managing a robotic charging system of a manufacturing environment

### BACKGROUND

The statements in this section merely provide background information related to the present disclosure and may not constitute prior art.

Electric propulsion systems in vehicles propel the vehicle as an alternative or in addition to internal combustion engines. The electric vehicles may operate autonomously (i.e., without human input) or semi-autonomously (i.e., with some human input). To charge the electric propulsion systems, electric chargers are manually placed onto charging ports to provide power to a power storage device, such as a battery. Manual charging increases the amount of human input needed for otherwise autonomous or semi-autonomous electric vehicles.

The present disclosure addresses challenges related to charging electric vehicles.

### SUMMARY

This section provides a general summary of the disclosure and is not a comprehensive disclosure of its full scope or all of its features.

In one form, the present disclosure provides a charging system for an electric vehicle that includes a robotic arm, a base, a vision sensor, a hook, a gripper, and an electric charger. The base is secured to the robotic arm. The vision sensor is disposed on the base. The hook extends from the base. The gripper extends below the base. The gripper also includes two opposing fingers configured to be retracted toward each other. The electric charger is configured to be secured between the opposing fingers. The robotic arm is configured to move the electric charger to a charging port of the electric vehicle opened by the hook based on data from the vision sensor.

In variations of the charging system of the above paragraph, which can be implemented individually or an any combination: the gripper further comprises an actuator configured to retract the two opposing fingers toward each other; the electric charger includes a release configured to disengage the electric charger from the charging port, and the system further comprises an actuator configured to actuate the release; the vision sensor is configured with an object detection algorithm trained to identify the charging port of the electric vehicle based on images collected by the vision sensor; the hook defines a void between a proximal end and a distal end; the distal end is configured to deform toward the proximal end into the void; the gripper includes a protrusion and the electric charger includes a slot configured to receive the protrusion, the protrusion is configured to locate the gripper relative to the electric charger when the protrusion is received by the slot; the charging system further includes a fastener securing the base to the robotic arm; and the hook is configured to open a charging port door of the electric vehicle.

In another form, the present disclosure provides a method for charging an electric vehicle. The method includes actuating a gripper of a tool attached to a robotic arm to secure an electric charger; pressing a distal end of the tool against a charging port cover to open the charging port cover; inserting a hook of the tool between a charging port door and a charging port of the electric vehicle; and moving the electric charger with the robotic arm into the charging port.

In variations of the method of the above paragraph, which can be implemented individually or an any combination: the method can further include collecting image data with a vision sensor and moving the robotic arm to press the distal end of the tool against the charging port cover based on the image data; the method can further include identifying the charging port door based on the image data and moving the robotic arm to insert the hook based on the identified charging port door; the method can further include actuating a solenoid actuator disposed on the tool to press a release on the electric charger to release the electric charger from the charging port; the method can further include actuating a pneumatic actuator to move opposing fingers of the gripper toward each other to secure the electric charger; and the method can further include closing the charging port cover with the hook.

In yet another form, the present disclosure provides a tool for a robotic arm that is configured to move an electric charger to an electric vehicle. The tool includes a base, a vision sensor, a hook, and a gripper. The base is configured to be secured to the robotic arm. The vision sensor is disposed on the base. The hook includes a proximal end fixed to the base, a distal end having an arcuate shape, and a void defined between the proximal end and the distal end. The gripper extends below the base and includes a track, two opposing fingers configured to move along the track, and an actuator configured to retract the two opposing fingers along the track.

In variations of the tool of the above paragraph, which can be implemented individually or an any combination: the distal end of the hook is configured to deform toward the proximal end of the hook into the void; the gripper further comprises a protrusion configured to be received by a slot of the electric charger; a solenoid actuator includes a rod, the solenoid actuator configured to push the rod onto a release of the electric charger; and the hook comprises a resilient polymer material.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a functional block diagram of an example manufacturing environment in accordance with the teachings of the present disclosure;

FIG. 1B is a schematic illustration of the example manufacturing environment of FIG. 1A in accordance with the teachings of the present disclosure;

FIG. 1C is a schematic illustration of an example charging port cover in accordance with the teachings of the present disclosure;

FIG. 2A is a functional block diagram of another example manufacturing environment in accordance with the teachings of the present disclosure;

FIG. 2B is a schematic illustration of the example manufacturing environment of FIG. 2A in accordance with the teachings of the present disclosure;

FIG. 3 is a perspective view of an end of arm tool and electric charger in accordance with the teachings of the present disclosure;

FIG. 4 is another perspective view of the end of arm tool of FIG. 3;

FIG. 5 is a bottom perspective view of the end of arm tool of FIG. 3;

FIG. 6 is a perspective view of the end of arm tool engaging a charging port cover in accordance with the teachings of the present disclosure;

FIG. 7 is a perspective view of the charging port cover of FIG. 6 opened by the end of arm tool;

FIG. 8 is a perspective view of the end of arm tool positioned to move a charge socket cover of the charging port cover from a closed position to an open position in accordance with the teachings of the present disclosure;

FIG. 9 is a perspective view of the end of arm tool moving the charge socket cover from the closed position to the open position;

FIG. 10 is a perspective view of the end of arm tool moving the electric charger to a charging port;

FIG. 11 is a perspective view of the electric charger engaging the charging port; and

FIG. 12 is a perspective view of the end of arm tool moving the charge socket cover from the open position to the closed position.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

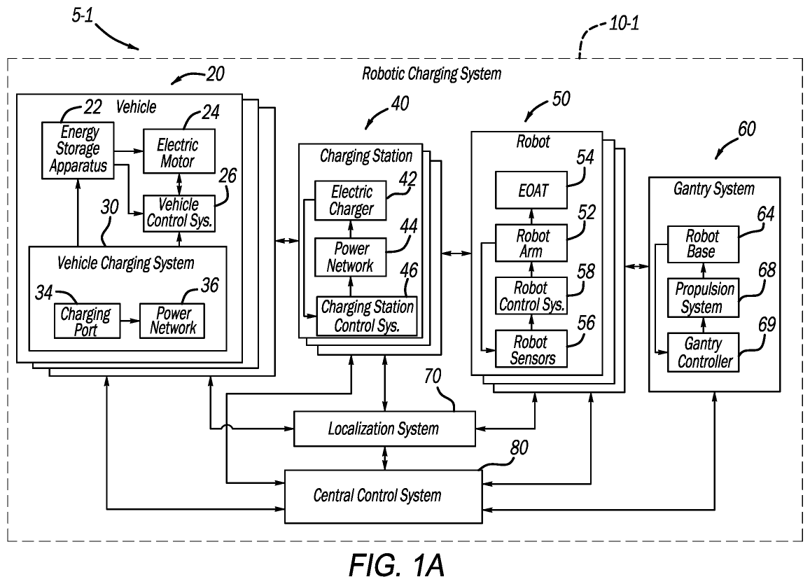

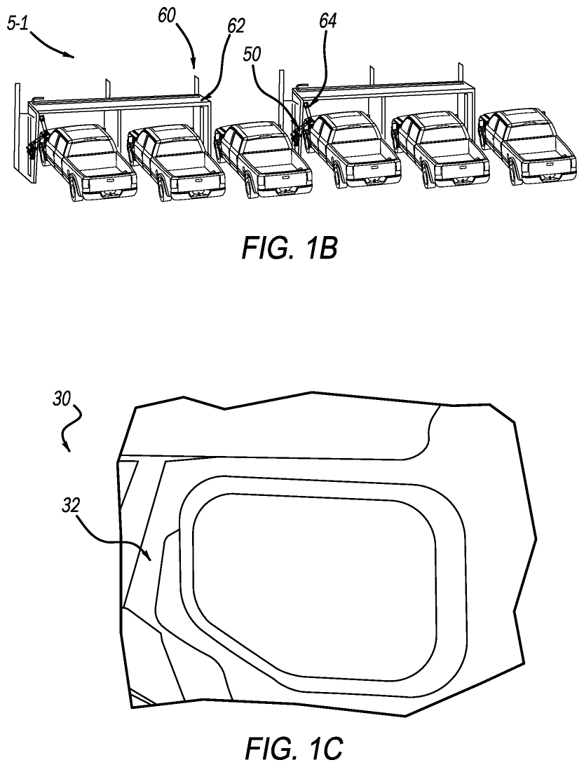

Referring to FIGS. 1A and 1B, a manufacturing environment 5-1 is shown and generally includes a robotic charging system 10-1 and a plurality of vehicles 20. In one form, the robotic charging system 10-1 includes a plurality of charging stations 40, a plurality of robots 50, a gantry system 60, a localization system 70, and a central control system 80. It should be understood that any one of the modules of the vehicles 20, the charging stations 40, the robots 50, the gantry system 60, the localization system 70, and the central control system 80 can be provided at the same location or distributed at different locations (e.g., via one or more edge computing devices) and communicably coupled accordingly. In one form, the vehicles 20, the charging stations 40, the robots 50, the gantry system 60, the localization system 70, and the central control system 80 (also referred to herein as a “central controller 80”) are communicably coupled using a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

In one form, the vehicles 20 are provided by electric vehicles. As used herein, “electric vehicle” refers to a vehicle that employs one or more electric motors for propulsion. Example electric vehicles include, but are not limited to, electric-only vehicles (EVs) and hybrid electric vehicles (HEVs). In one form, the vehicles 20 may be provided by autonomous or semi-autonomous vehicles that are configured to perform one or more known autonomous routines within the manufacturing environment 5-1, such as an autonomous navigation routine, a driver assistance routine, an adaptive cruise control routine, an autonomous braking routine, and/or an object detection routine. It should be understood that the vehicles 20 may be provided by other types of vehicles and are not limited to the examples described herein.

In one form, the vehicles 20 may each include an electric motor 24 that employ electrical energy stored in an energy storage apparatus 22, such as one or more vehicle batteries, to perform one or more propulsion-based operations. In one form, the vehicles 20 includes a vehicle control system 26 that is configured to control and/or monitor a particular system or subsystem of the vehicle 20. As an example, the vehicle control system 26 may include a propulsion control module for controlling the operation of the electric motor 24, a powertrain control module for controlling operation of a powertrain system of the vehicle 20, a transmission control module for controlling operation of a transmission system of the vehicle 20, a brake control module for controlling operation of a braking system of the vehicle 20, a body control module for controlling the operation of various electronic accessories in the body of the vehicle 20, a climate control module for controlling operation of a heating and air conditioning system of the vehicle 20, and a suspension control module for controlling operation of a suspension system of the vehicle 20, among other vehicle modules. In one form, the electric motor 24, the energy storage apparatus 22, and the vehicle control system 26 are communicably coupled by a vehicle interface, such as a control system area network (CAN) bus, a local interconnect network (LIN) bus, and/or a clock extension peripheral interface (CXPI) bus. In one form, the vehicle control system 26 is configured to provide vehicle data associated with the given vehicle 20 to the central control system 80.

In one form and referring to FIGS. 1A-1C, the vehicles 20 may each include a vehicle charging system 30 that is configured to receive electrical energy from the charging stations 40. The vehicle charging system 30 may include a charging port cover 32, a charging port 34, and a power network 36. In one form, the charging port cover 32 is configured to physically isolate the charging port 34 and the power network 36 from an ambient environment of the vehicle 20 and may be provided by, for example, a door or cap.

In one form, the charging port 34 provides an electrical interface for physically and electrically/inductively coupling an electrical charger of the charging station 40 (described below in further detail) to the power network 36. As an example, the charging port 34 is provided by a charging receptacle (e.g., an electrical outlet) that receives one or more conductive components of the electrical charger of the charging station 40. As another example, the charging port 34 is provided by a charging pad (e.g., a wireless power transfer pad comprising one or more inductive coils) that is configured to inductively and physically couple to a charging pad of the electrical charger.

In one form, the power network 36 selectively adjusts one or more characteristics of the electric signal received from the charging stations 40 and provides the adjusted signal to the energy storage apparatus 22. As an example, the power network 36 includes an alternating current-alternating current (AC-AC) converter circuit that is configured to adjust an amplitude and/or frequency component of an AC electric signal, such as a voltage source inverter, a current source inverter, a cycloconverter, a matrix converter, among other AC-AC converter circuits. As another example, the power network 36 includes an AC-direct current (AC-DC) converter circuit that is configured to convert the AC electric signal into a DC electric signal, such as a rectifier circuit and/or other AC-DC converter circuits. As an additional example, the power network 36 includes a DC-AC converter circuit that is configured to convert the DC electric signal into an AC electric signal, such as an inverter circuit and/or other DC-AC converter circuits. As yet another example, the power network 36 includes a DC-DC converter circuit that is configured to adjust an amplitude of the DC electric signal, such as a buck converter circuit, a boost converter circuit, a buck-boost converter circuit, among other DC-DC converter circuits.

In one form, the charging stations 40 are configured to provide electrical energy to the vehicles 20 during a charging operation and include an electric charger 42, a power converter network 44, and a charging station control system 46. In one form, the electric charger 42 is electrically coupled to a power grid via the power converter network 44 and may include a conductive cable and a charging interface for physically and electrically/inductively coupling to the power network 36 via the charging port 34, such as a plug or a wireless charging pad. In one form, the power network 44 is configured to adjust one or more characteristics of the electrical power output by the grid and provide the adjusted electrical power to the energy storage apparatus 22 via the charging port 34 and the power network 36. As an example, the power network 44 may include similar circuits and converter networks as the power network 36, and as such, the description thereof is omitted for brevity.

In one form, the robots 50 include a robotic arm 52, an end of arm tool (EOAT) 54, robot sensors 56, and a robot control system 58 configured to control the robotic arm 52 and the EOAT 54 to perform one or more automated tasks. Example automated tasks include, but are not limited to, retrieving the electric charger 42 from the charging station 40 and moving the electric charger 42 proximate to the vehicle 20 (e.g., the charging port 34), removing the charging port cover 32 to insert the electric charger 42 into the charging port 34, among other automated tasks.

In one form, the robotic arm 52 is a multi-axis robotic arm having various portions that are rotatable about various axes (e.g., a six-axis robot having five degrees of freedom). In one form, the EOAT 54 includes one or more components for performing the automated tasks described herein, such as an image/vision sensor, a hook, and a gripper.

In one form, the robot sensors 56 generate data corresponding to various characteristics of the robot 50. As an example, the robot sensors 56 may include a location sensor (e.g., an NFC sensor or UWB sensor) configured to generate location information of the robot 50. As another example, the robot sensors 56 may include an accelerometer, a gyroscope, and/or a magnetometer configured to generate orientation information of the robot 50. As yet another example, the robot sensors 56 may include a velocity sensor configured to generate velocity information of the robot 50, a power sensor to generate power information (e.g., information regarding amount of current and/or voltage being applied by a power source to the robot 50), a torque sensor configured to generate torque information of various joints of the robot 50, and/or a touch sensor at a handle of the robot 50 configured to detect contact. The robot sensors 56 are configured to provide the corresponding data to the robot control system 58 for controlling the robotic arm 52 and/or EOAT 54.

In one form, the gantry system 60 includes a structural base 62, a robot base 64, a plurality of tracks (not specifically shown), a propulsion system 68, and a gantry control system 69. The structural base 62 is secured to the floor and is configured to physically support the robot base 64, which are generally disposed above the ground. In one variation, the structural base 62 is secured to the ceiling, wall, or other infrastructure element within the manufacturing environment 5-1, and the robot base 64 and the tracks are suspended therefrom such that they are disposed above the ground. In one form, the robot base 64 is secured to the robot 50, disposed within a recess defined by the tracks, and moveable along the tracks (e.g., slidably moveable via a plurality of wheels of the robot base 64) such that the robot 50 can initiate the charging operation at any one of the charging stations 40. In one form, the tracks have a one-dimensional, two-dimensional, or three-dimensional arrangement to enable the robot base 64 to move along various axes. In one form, the propulsion system 68 includes various known components for moving the robot base 64 and the attached robot 50 along the plurality of tracks. As an example, the propulsion system 68 includes drive motors, cable carriers, electrically conductive wires, and other known components that are employed for moving the robot base 64 and the attached robot 50 along the plurality of tracks.

In one form, the localization system 70 is configured to localize the robots 50 relative to the vehicles 20 and/or the vehicles 20 relative to the robots 50. That is, the localization system 70 is configured to convert a robot-based position of the robot 50 to a vehicle-based position of the robot 50, a vehicle-based position of the vehicle 20 to a robot-based position of the vehicle 20, or a combination thereof. As an example, the localization system 70 may employ known imaging and fiducial marker systems that employ predefined robot/vehicle location coordinates and translation routines for localizing the robots 50 relative to the vehicles 20 and/or the vehicles 20 relative to the robots 50. As another example, the localization system 70 may employ known object detection systems having predefined robot/vehicle location coordinates and translation routines for localizing the robots 50 relative to the vehicles 20 and/or the vehicles 20 relative to the robots 50, such as a guard rail system. Example details regarding guard rail systems that are employed for localizing the robots 50 relative to the vehicles 20 and/or the vehicles 20 relative to the robots 50 are disclosed in U.S. patent application Ser. No. ______, and titled “SYSTEM AND METHOD FOR CHARGING ELECTRIC VEHICLES,” which is commonly owned with the present application and the contents of which are incorporated herein by reference in its entirety.

In one form, the central control system 80 is configured to control the operation of the robotic charging system 10-1. As an example, the central control system 80 obtains robot data associated with the robots 50, vehicle data associated with the vehicles 20, and charging station data associated with the charging stations 40. Furthermore, the central control system 80 determines whether one of the vehicles 20 has an amount of electrical energy stored in the corresponding energy storage apparatus 22 that is less than a threshold amount and instructs a selected robot 50 and the vehicle 20 to a selected charging station 40 to thereby perform the charging operation.

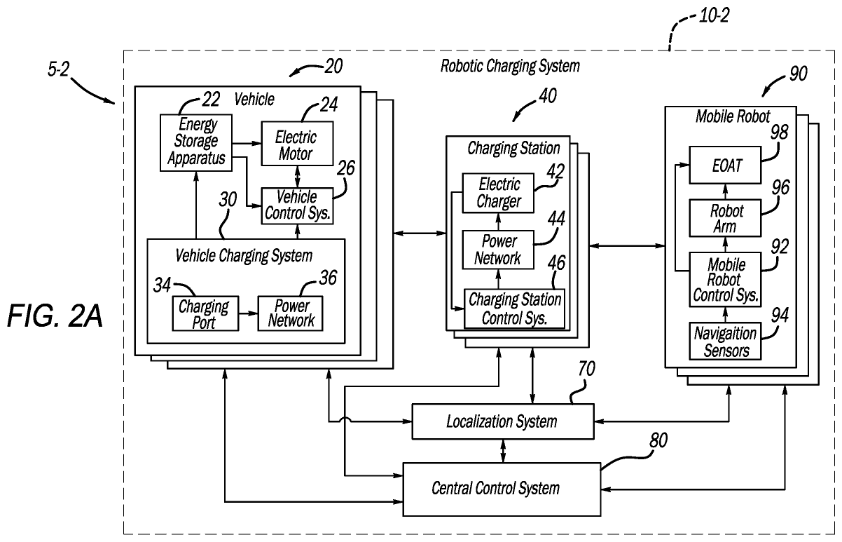

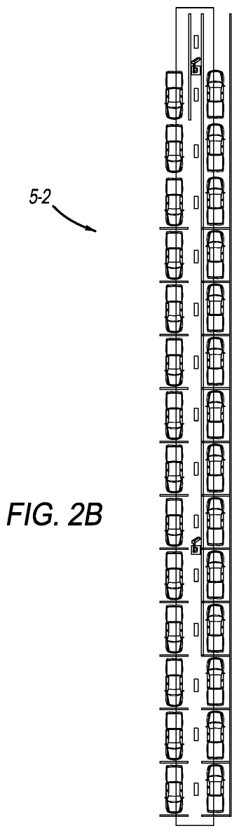

Referring to FIGS. 2A and 2B, a manufacturing environment 5-2 is shown and generally includes a robotic charging system 10-2. The robotic charging system 10-2 is similar to the robotic charging system 10-1, except that the robots 50 and the gantry system 60 are replaced with a plurality of mobile robots 90. In one form, the mobile robots 90 are configured to autonomously move to various locations of the manufacturing environment 5-2, as instructed by the central control system 80. To autonomously move itself, a mobile robot control system 92 is configured to control various movement systems of the mobile robot 90 (e.g., propulsion systems, steering systems, and/or brake systems) via actuators and based on one or more navigation sensors 94 (e.g., a global navigation satellite system (GNSS) sensor, a vision sensor, a local position sensor, among others). Furthermore, the mobile robot control system 92 is configured to operate the actuators to control the motion of one or more robotic arms 96 and an EOAT 98 attached thereto and thereby perform one or more automated tasks. Example automated tasks include, but are not limited to, autonomously traveling to a given charging station 40 identified by the central control system 80, retrieving the electric charger 42 from the charging station 40 and moving the electric charger 42 proximate to the vehicle 20 (e.g., the charging port 34), removing the charging port cover 32 to insert the electric charger 42 into the charging port 34, among other automated tasks.

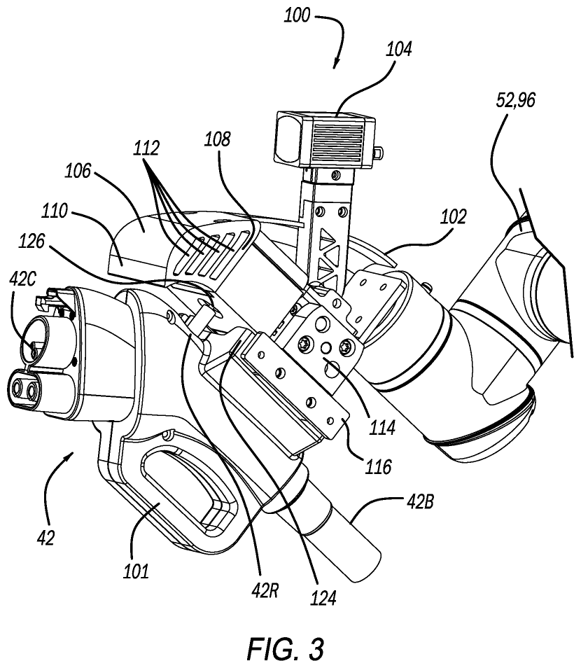

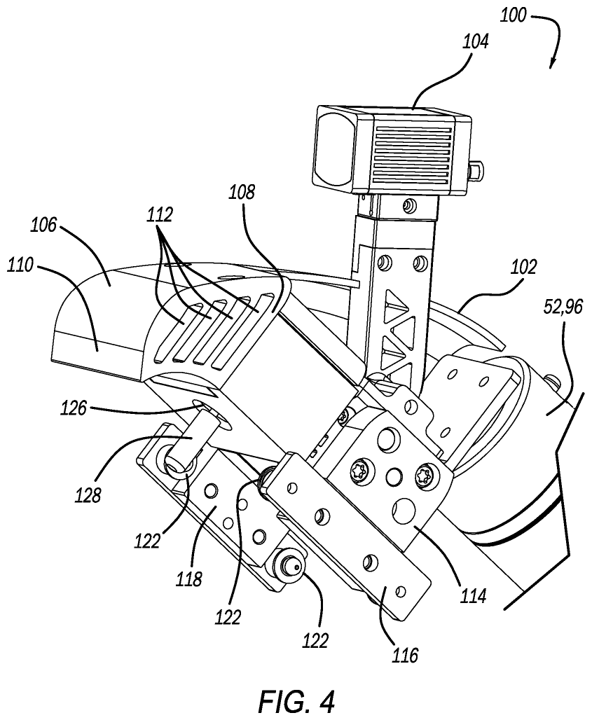

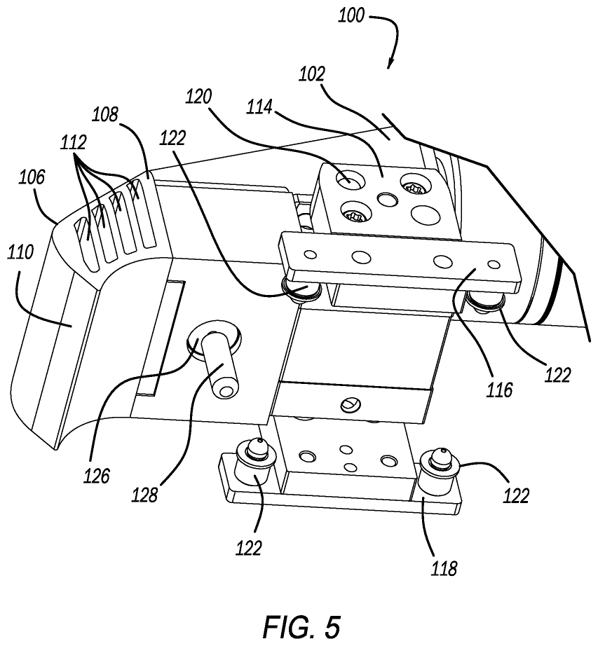

With reference to FIGS. 3-5, the EOAT 54, 98 can be a tool 100 in one form. The tool 100 is attachable to the robotic arm 52, 96 described above. The tool 100 is configured to move the electric charger 42 to and from the charging port 34 to provide power to the vehicle 20. The electric charger 42 includes a base 42B, a charging connection 42C, and a release 42R. The base 42B supports the other components of the electric charger 42, and more specifically, the tool 100 grabs the electric charger 42 at the base 42B. The charging connection 42C engages the charging port 34 to provide electricity from the power network 44 of the charging station 40 to the power network 36 of the vehicle charging system 30. The electric charger 42 includes a lock (not shown) configured to hold the electric charger 42 to the charging port 34, and the release 42R is configured to disengage the lock from the charging port 34.

The tool 100 includes a base 102. The base 102 is secured to the robotic arm 52, 96 with a fastener, such as a bolt. The base 102 supports the other components of the tool 100, as described below in further detail. In one form, four fasteners (not shown) secure the base 102 to the robotic arm 52, 96, inhibiting movement of the tool 100 relative to the robotic arm 52, 96. The fasteners are a suitable type, such as bolts, pins, screws, or the like. In another form, a different number of fasteners secures the base 102 to the robotic arm 52, 96.

The tool 100 includes a vision sensor 104. The vision sensor 104 is disposed on the base 102. The vision sensor 104 collects visual image data and transmits the data to the central controller 80. Based on the visual image data, the central controller 80 provides instructions to the robot 50, 90 to operate the tool 100. More specifically, the central controller 80 provides instructions to operate the robotic arm 52, 96 to move the electric charger 42 attached to the tool 100 to the charging port 34 based on the visual image data collected by the vision sensor 104.

In one form, the vision sensor 104 is configured with an object detection algorithm trained to identify the charging port 34 based on images collected by the vision sensor 104. The object detection algorithm is a conventional image processing technique, such as Canny edge detection or deep learning. In another form, the central controller 80 is configured with the object detection algorithm and, based on data from the localization system 70, locates the charging port 34 based on the image data. In one form, the visual image data include coordinate data, such as two-dimensional or three-dimensional coordinate data, that the localization system 70 is configured to process into a global coordinate system. Based on the localizing performed by the localization system 70, the central controller 80 is configured to identify objects and locations of objects in the visual image data.

The tool 100 includes a hook 106 extending from the base 102. The hook 106 is configured to open and close the charging port door of the electric vehicle 20. The hook 106 is further configured to open and close an optional charge socket cover (e.g., a DC faster charge socket cover) of the vehicle charging port 34. More specifically, the hook 106 has an arcuate shape that separates a portion of the charging port door from the charging port 34 of the electric vehicle 20, revealing the charging port 34 for connection to the electric charger 42. The hook 106 extends from a proximal end 108 to a distal end 110. The proximal end 108 is fixed to the base 102, and the distal end 110 has an arcuate shape extending along a length of the hook 106. In one form, the hook 106 defines one or more voids 112 between the proximal end 108 and the distal end 110. The voids 112 allow the distal end 110 to deform toward the proximal end 108, inhibiting damage to the hook 106. That is, the hook 106 is formed of or otherwise comprises a resilient polymer material that has a stiffness sufficient to press against the charging port cover 32 and to open the charging port door and also sufficiently flexible to inhibit damage upon contact with another component.

The tool 100 includes a gripper 114 extending below the base 102. The gripper 114 is configured to grab and release the electric charger 42, securing the electric charger 42 in place while the robotic arm 52, 96 positions the electric charger 42 in the charging port 34. The gripper 114 includes a first finger 116, a second finger 118 opposing the first finger 116, and an actuator 120 configured to retract the two opposing fingers 116, 118 toward each other. The first and second fingers 116, 118 secure the electric charger 42 therebetween when retracted toward each other, and the first and second fingers 116, 118 release the electric charger 42 when moved away from each other. That is, the actuator 120 is a pneumatic actuator that includes a two-way cylinder with a first end connected to the first finger 116 and a second end connected to the second finger 118. The actuator 120 retracts the first and second ends of the cylinder to move the first and second fingers 116, 118 toward each other and pushes the first and second ends to move the first and second fingers 116, 118 away from each other.

In one form, the gripper 114 includes one or more protrusions 122 extending from the first and second fingers 116, 118. The electric charger 42 includes one or more slots 124 configured to receive the protrusions 122. The protrusions 122 and slots 124 are configured to locate the gripper 114 relative to the electric charger 42. That is, when the protrusions 122 are disposed in the slots 124, the gripper 114 and the electric charger 42 are fixed into a specific orientation in the coordinate system, thereby “locating” the gripper 114 relative to the electric charger 42. The central controller 80 and the localization system 70 identify the specific orientation as a set of default three-dimensional coordinates that are used to determine the three-dimensional position of the gripper 114 and the electric charger 42. The central controller 80 thus moves the robotic arm 52, 96 based on coordinate information provided by the locating function of the protrusions 122 and the slots 124. In some forms, the gripper 114 may include a sensor (e.g., a proximity sensor) disposed thereon to detect a position of the gripper 114 (e.g., the proximity sensor may determine whether the fingers 116, 118 of the gripper 114 are retracted toward each other or are moved away from each other).

The tool 100 includes a release actuator 126 configured to actuate the release 42R of the electric charger 42. The release actuator 126 is disposed in the base 102 and extends toward the electric charger 42. More specifically, the release actuator 126 includes a rod 128 that is positioned proximate to the release 42R when the gripper 114 secures the electric charger 42. The release actuator 126 pushes the rod 128 onto the release 42R, which releases the lock of the electric charger 42 and allows the tool 100 to remove the electric charger 42 from the charging port 34. In one form, the release actuator 126 is a solenoid actuator. In another form, the release actuator 126 is another suitable device that pushes the rod 128 onto the release 42R, such as a pneumatic actuator, a hydraulic actuator, a linear actuator, or the like. The tool 100 may also include a handle 101 (FIG. 3) for manual movement of the electric charger 42.

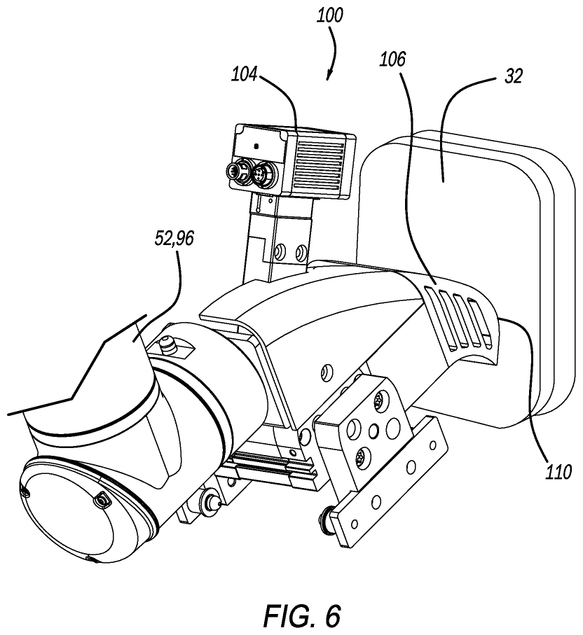

With references to FIGS. 6-12, a process for charging the electric vehicle 20 with the charging system 10 is shown. In the following FIGS., for clarity, not all components of the tool 100 may include reference numerals. It is understood that components shown in FIGS. 6-12 correspond to the components which are numbered in FIGS. 3-5. The process begins as shown in FIG. 6, in which the robotic arm 52, 96 moves the tool 100 to press the hook 106 against the charging port cover 32. Specifically, the central controller 80 collects image data from the vision sensor 104 and moves the tool 100 according to the image data to align the hook 106 with the charging port cover 32. Then, the central controller 80 actuates the robotic arm 52, 96 to move the tool 100 toward the charging port cover 32 until the distal end 110 of the hook 106 is pressed against the charging port cover 32. The hook 106 may deform into the voids 112 when pressed against the charging port cover 32.

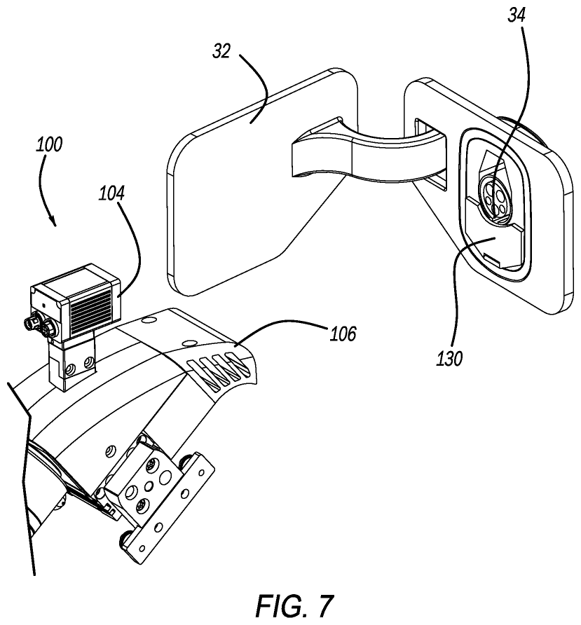

Next, as shown in FIG. 7, the robotic arm 52, 96 moves the tool 100 away from the charging port cover 32, allowing the charging port cover 32 to open. The vehicle 20 includes a device (not shown) that opens the charging port cover 32 to an opened position without further input from the tool 100, exposing the charging port 34. The central controller 80 collects image data from the vision sensor 104 to confirm that the charging port cover 32 is open.

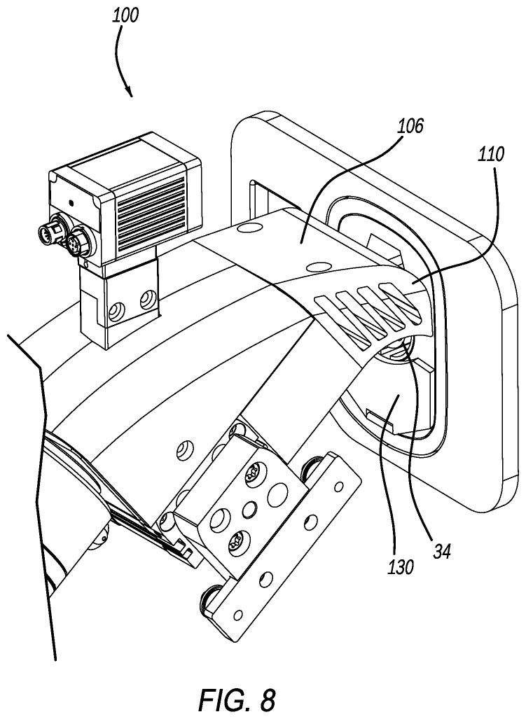

Next, as shown in FIG. 8, the robotic arm 52, 96 moves the tool 100 to an optional charge socket cover 130 of the charging port 34. Specifically, the central controller 80 collects image data from the vision sensor 104 and, based on the image data, identifies the charge socket cover 130. The central controller 80 then actuates the robotic arm 52, 96 to align the hook 106 with the charge socket cover 130. The central controller 80 then actuates the robotic arm 52, 96 to insert the distal end 110 of the hook 106 between the charge socket cover 130 and the charging port 34.

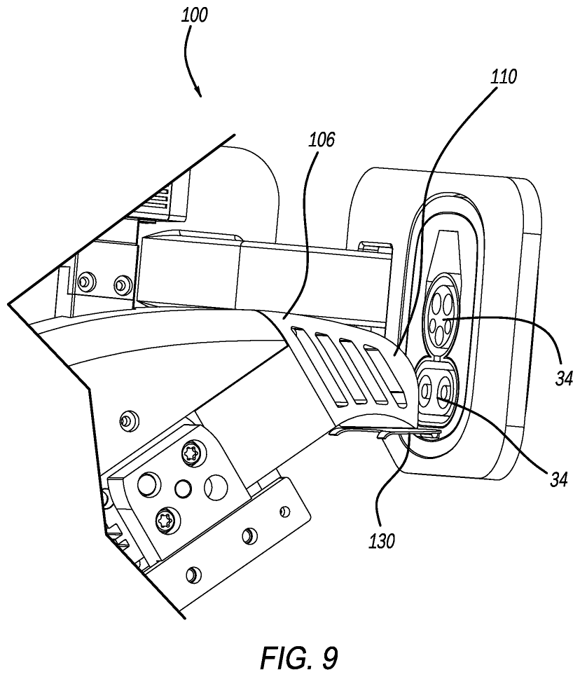

Next, as shown in FIG. 9, the central controller 80 then actuates the robotic arm 52, 96 to move the tool 100 in a vertically downward direction, opening the charge socket cover 130 to an opened position. The central controller 80 instructs the robotic arm 52, 96 to move the tool 100 a specified distance in the vertical direction, the specified distance being based on a height of the charge socket cover 130 determined by the collected image data. The inserted hook 106, upon moving vertically downward, moves the charge socket cover 130 away from the charging port 34, thereby exposing charge socket cover. The vision sensor 104 collects image data of the charge socket cover 130 and transmits the image data to the central controller 80 to confirm that the charge socket cover 130 is open.

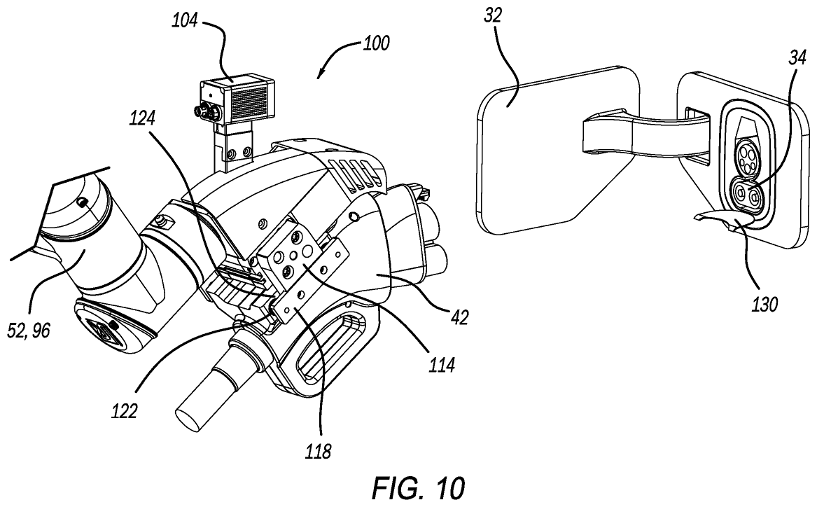

Next, as shown in FIG. 10, the central controller 80 actuates the robotic arm 52, 96 to grab the electric charger 42 with the tool 100. Specifically, the central controller 80 actuates the robotic arm 52, 96 to move the tool 100 and aligns the gripper 114 with the electric charger 42. Then, the central controller 80 actuates the actuator 120 to move the opposing fingers 116, 118 of the gripper 114 toward each other. Because the electric charger 42 is disposed between the fingers 116, 118, the protrusions 122 of the gripper 114 engage the slots 124 of the electric charger 42, securing the electric charger 42 in the gripper.

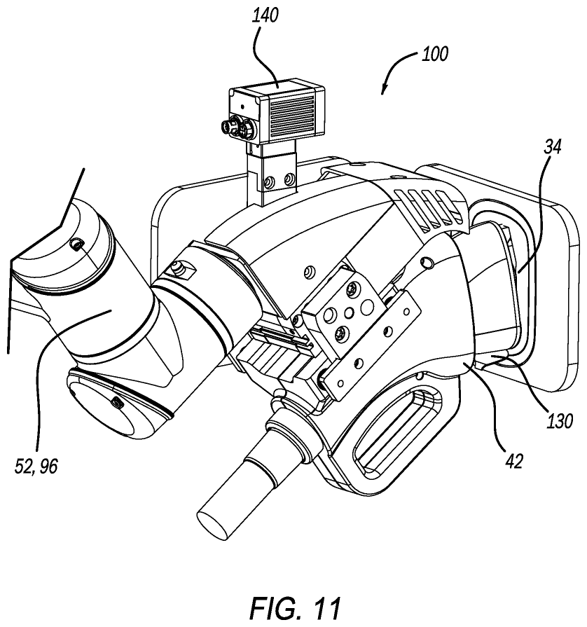

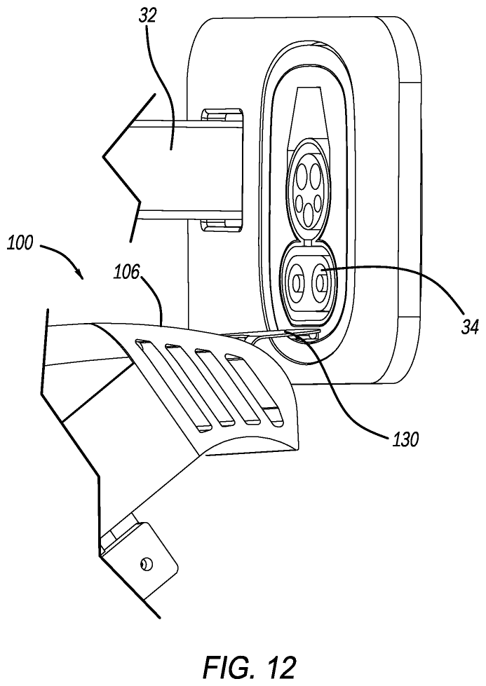

Next, as shown in FIG. 11, the central controller 80 actuates the robotic arm 52, 96 to move the electric charger 42 into the charging port 34. Specifically, the central controller 80 uses image data collected by the vision sensor 104 to move the tool 100 so that the electric charger 42 engages the charging port 34. When the electrical charger 42 engages the charging port 34, the power network 44 of the charging station 40 provides electricity to the power network 36 of the vehicle charging system 30, charging the energy storage apparatus 22. The electric charger 42 remains against the electric port 34 until the energy storage apparatus 22 is fully charged. While the electric charger 42 charges the energy storage apparatus 22, the central controller 80 may disengage the tool 100 from the electric charger 42 and move another electric charger 42 to another vehicle 20.

Next, not shown in the FIGS., once the energy storage apparatus 22 is charged, the central controller 80 actuates the release actuator 126 to release the electric charger 42 from the charging port 34. Specifically, the release actuator 126 moves the rod 128 onto the release 42R, which disengages the lock holding the electric charger 42 to the charging port 34. The central controller 80 then actuates the robotic arm 52, 96 to move the released electric charger 42 away from the charging port 34. The robotic arm 52, 96 moves the electric charger 42 to a storage location and actuates the gripper 114 to release the electric charger 42 from the tool 100. The vision sensor 104 collects image data of the electric charger 42 stored in the storage location and transmits the image data to the central controller 80 to confirm that the electric charger 42 is stored.

Next, as shown in FIG. 12, the central controller 80 actuates the robotic arm 52, 96 to close the charging port cover 32 with the hook 106. Specifically, the central controller 80, based on the image data collected by the vision sensor 104, actuates the robotic arm 52, 96 to position the hook 106 beneath the charge socket cover 130. Then, the robotic arm 52, 96 moves the hook 106 in a vertically upward direction, moving the charge socket cover 130 onto the charging port 34. Then, the robotic arm 52, 96 positions the hook 106 adjacent to the charging port cover 32 and moves the tool 100 such that the hook 106 pushes the charging port cover 32 toward the charging port 34. Then, the robotic arm 52, 96 moves the hook 106 to press the charging port cover 32 against the charging port 34, securing the charging port cover 32 to the vehicle 20. The central controller 80 then actuates the robotic arm 52, 96 to move the tool 100 away from the vehicle 20. The vision sensor 104 collects image data of the closed charging port cover 32 and transmits the image data to the central controller 80. Once the central controller 80 confirms that the charging port cover 32 is closed, the process finishes.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A charging system for an electric vehicle, the system comprising:
a robotic arm;
a base secured to the robotic arm;
a vision sensor disposed on the base;
a hook extending from the base;
a gripper extending below the base, the gripper including two opposing fingers configured to be retracted toward each other; and
an electric charger configured to be secured between the two opposing fingers,
wherein the robotic arm is configured to move the electric charger to a charging port of the electric vehicle opened by the hook based on data from the vision sensor.

2. The charging system of claim 1, wherein the gripper further comprises an actuator configured to retract the two opposing fingers toward each other.

3. The charging system of claim 1, wherein the electric charger includes a release configured to disengage the electric charger from the charging port, and the system further comprises an actuator configured to actuate the release.

4. The charging system of claim 1, wherein the vision sensor is configured with an object detection algorithm trained to identify the charging port of the electric vehicle based on images collected by the vision sensor.

5. The charging system of claim 1, wherein the hook defines a void between a proximal end and a distal end.

6. The charging system of claim 5, wherein the distal end is configured to deform toward the proximal end into the void.

7. The charging system of claim 1, wherein the gripper includes a protrusion and the electric charger includes a slot configured to receive the protrusion, the protrusion configured to locate the gripper relative to the electric charger when the protrusion is received by the slot.

8. The charging system of claim 1, further comprising a fastener securing the base to the robotic arm.

9. The charging system of claim 1, wherein the hook is configured to open a charging port door of the electric vehicle.

10. A method for charging an electric vehicle, the method comprising:
actuating a gripper of a tool attached to a robotic arm to secure an electric charger;
pressing a distal end of the tool against a charging port cover to open the charging port cover;
inserting a hook of the tool between a charging port door and a charging port of the electric vehicle; and
moving the electric charger with the robotic arm into the charging port.

11. The method of claim 10, further comprising collecting image data with a vision sensor and moving the robotic arm to press the distal end of the tool against the charging port cover based on the image data.

12. The method of claim 11, further comprising identifying the charging port door based on the image data and moving the robotic arm to insert the hook based on the identified charging port door.

13. The method of claim 10, further comprising actuating an actuator disposed on the tool to press a release on the electric charger to release the electric charger from the charging port.

14. The method of claim 10, further comprising actuating a pneumatic actuator to move opposing fingers of the gripper toward each other to secure the electric charger.

15. The method of claim 10, further comprising closing the charging port cover with the hook.

16. A tool for a robotic arm configured to move an electric charger to an electric vehicle, the tool comprising:
a base configured to be secured to the robotic arm;
a vision sensor disposed on the base;
a hook including a proximal end fixed to the base, a distal end having an arcuate shape, and a void defined between the proximal end and the distal end; and
a gripper extending below the base, the gripper including a track, two opposing fingers configured to move along the track, and an actuator configured to retract the two opposing fingers along the track.

17. The tool of claim 16, wherein the distal end of the hook is configured to deform toward the proximal end of the hook into the void.

18. The tool of claim 16, wherein the gripper further comprises a protrusion configured to be received by a slot of the electric charger.

19. The tool of claim 16, further comprising a solenoid actuator including a rod, the solenoid actuator configured to push the rod onto a release of the electric charger.

20. The tool of claim 16, wherein the hook comprises a resilient polymer material.
